(19) United States
(12) Patent Application Publication
(10) Pub. No.: US 2015/0212727 A1
(43) Pub. Date: Jul. 30, 2015

(54) HUMAN-COMPUTER INTERACTION METHOD, AND RELATED DEVICE AND SYSTEM

(71) Applicant: Tencent Technology (Shenzhen) Company Limited, Shenzhen (CN)

(72) Inventors: Jin FANG, Shenzhen (CN); Jian DU, Shenzhen (CN); Yan CHEN, Shenzhen (CN); Mu TANG, Shenzhen (CN); Jinsong JIN, Shenzhen (CN); Jun CHENG, Shenzhen (CN)

(21) Appl. No.: 14/677,883

(22) Filed: Apr. 2, 2015

Related U.S. Application Data
(63) Continuation of application No. PCT/CN2013/080324, filed on Jul. 29, 2013.

(30) Foreign Application Priority Data
Oct. 15, 2012 (CN) 201210388925.9

(51) Int. Cl. G06F 3/0488; G06F 3/042

(52) U.S. Cl. CPC G06F 3/04883; G06F 3/0425; G06F 2203/04808

(57) ABSTRACT

The present disclosure relates to the field of human-computer interaction techniques, and discloses a human-computer interaction method, and a related device and system. The method includes: capturing, by a terminal device by using a camera module, an auxiliary light source formed by a finger gesture on an auxiliary light screen; determining, by the terminal device, a position and/or a motion track of the auxiliary light source in an image captured by the camera module; and executing, by the terminal device, a corresponding operation instruction according to the position and/or the motion track. By implementing the present disclosure, an anti-interference performance of a finger gesture input can be improved and therefore operational accuracy can be improved.

### RELATED APPLICATIONS

This patent application is a continuation application of PCT Patent Application No. PCT/CN2013/080324, entitled “HUMAN-COMPUTER INTERACTION METHOD, AND RELATED DEVICE AND SYSTEM” filed on Jul. 29, 2013, which claims priority to Chinese Patent Application No. 201210388925.9, entitled “HUMAN-COMPUTER INTERACTION METHOD, AND RELATED DEVICE AND SYSTEM” filed on Oct. 15, 2012, both of which are incorporated by reference in their entirety.

### FIELD OF THE TECHNOLOGY

The present disclosure relates to the field of human-computer interaction techniques, and in particular, to a human-computer interaction method, and a related device and system.

### BACKGROUND OF THE DISCLOSURE

Human-computer interaction techniques generally refer to techniques for implementing dialogues between people and a terminal device effectively by using an input/output device of the terminal device (for example, a computer or a smart phone). The techniques include that the terminal device provides a large quantity of related information, prompts, requests, and the like for people by using an output device or a display device, and that people input a related operation instruction into the terminal device by using an input device, to control the terminal device to execute a corresponding operation. The human-computer interaction techniques are one of important parts in computer user interface designing and are closely associated with subject areas such as cognition, human engineering, and psychology.

The human-computer interaction techniques have evolved their input manners gradually from the primary keyboard input and mouse input to touch screen input and finger gesture input. The gesture input has advantages such as direct operation and high user experience and is increasingly favored by people. However, in practical applications, the finger gesture input generally is implemented by directly capturing and interpreting a finger gesture by using an ordinary camera. Through practices, it is found that directly capturing and interpreting a finger gesture by using an ordinary camera has a poor anti-interference performance, thereby causing low operational accuracy.

### SUMMARY

In the existing technology, directly capturing and interpreting a finger gesture by using an ordinary camera has a poor anti-interference performance and causes low operational accuracy.

In view of the above, the present disclosure provides a human-computer interaction method and related device and system, which are capable of improving an anti-interference performance of a finger gesture input, thereby improving the operational accuracy.

According to one aspect of the present disclosure, the human-computer interaction method, which is at a terminal device having one or more processors and memory for storing program modules to be executed by the one or more processors, includes:

capturing, using a camera module, an image including an auxiliary light source formed by a finger gesture on an auxiliary light screen located in front of the camera module;

processing the image to acquire an image that only displays the auxiliary light source formed by the finger gesture on the auxiliary light screen;

determining a position and/or a motion track of the auxiliary light source in the image captured by the camera module; and

executing a corresponding operation instruction according to the position and/or the motion track.

Correspondingly, according to another aspect of the present disclosure, a terminal device has one or more processors, memory, and one or more program modules stored in the memory and to be executed by the one or more processors, the one or more program modules further comprising:

a camera module, configured to capture an image including an auxiliary light source formed by a finger gesture on an auxiliary light screen located in front of the camera module;

a processing module, configured to process the image to acquire an image that only displays the auxiliary light source formed by the finger gesture on the auxiliary light screen;

a determining module, configured to determine a position and/or a motion track of the auxiliary light source in an image captured by the camera module; and

an executing module, configured to execute a corresponding operation instruction according to the position and/or the motion track.

Correspondingly, according to another aspect of the present disclosure, a human-computer interaction system, comprising an auxiliary light screen, a camera, and a terminal device, the camera being built into the terminal device or being connected to the terminal device in a wired or wireless manner, and a photographing area of the camera covering a working coverage area of the auxiliary light screen;

the auxiliary light screen being touched by a finger so as to form an auxiliary light source;

the camera capturing the auxiliary light source formed by the finger gesture on the auxiliary light screen; and

the terminal device further including:
a processing module, configured to process the image to acquire an image that only displays the auxiliary light source formed by the finger gesture on the auxiliary light screen;
a determining module, configured to determine a position and/or a motion track of the auxiliary light source in an image captured by the camera; and
an executing module, configured to execute a corresponding operation instruction according to the position and/or the motion track.

As can be known from the foregoing technical solutions, in the described aspects of the present disclosure, the terminal device can capture, by using the camera module, an auxiliary light source formed by a finger gesture on an auxiliary light screen, determine a position and/or a motion track of the auxiliary light source in an image captured by the camera module, further query for a code corresponding to the position and/or the motion track, and execute an operation instruction corresponding to the code. It can be seen from the above that, the present disclosure implements a human-computer interaction on the basis of an auxiliary light source, which not only achieves a very good anti-interference performance and higher operational accuracy, but also has a great commercial value.

### BRIEF DESCRIPTION OF THE DRAWINGS

To describe the technical solutions of the embodiments of the present application or the existing technology more clearly, the following briefly introduces the accompanying drawings required for describing the embodiments or the existing technology. Apparently, the accompanying drawings in the following description show only some embodiments of the present application, and a person of ordinary skill in the art may still derive other drawings from these accompanying drawings without creative efforts.

FIG. 1 is a flowchart of a human-computer interaction method according to some embodiments of the present application;

FIG. 2 is a flowchart of another human-computer interaction method according to another embodiment of the present application;

FIG. 3 is a schematic diagram of an implementation of an auxiliary light screen according to some embodiments of the present application;

FIG. 4 is a schematic diagram of processing an image captured by a camera according to some embodiments of the present application;

FIG. 5 is a schematic diagram of dividing an image captured by a camera into blocks according to some embodiments of the present application;

FIG. 6 is a flowchart of another human-computer interaction method according to some embodiments of the present application;

FIG. 7 is a schematic diagram of a motion track of an image captured by a camera in blocks according to some embodiments of the present application;

FIG. 8 is a structural diagram of a terminal device according to some embodiments of the present application; and

FIG. 9 is a structural diagram of a human-computer interaction system according to some embodiments of the present application.

### DESCRIPTION OF EMBODIMENTS

The following describes in details the respective embodiments of the present application with reference to the accompanying drawings in the embodiments of the present application. Apparently, the described embodiments are only some of the embodiments of the present application rather than all of the embodiments. All other embodiments obtained by a person of ordinary skill in the art based on the embodiments of the present application without creative efforts shall fall within the protection scope of the present disclosure.

The embodiments of the present application provide a human-computer interaction method, and a related device and system. In the human-computer interaction method, a terminal device captures, by using a camera module, an auxiliary light source formed by a finger gesture on an auxiliary light screen, and determines a position and/or a motion track of the auxiliary light source in an image captured by the camera module. Further, the terminal device executes a corresponding operation instruction according to the position and/or the motion track. The human-computer interaction method of the embodiments of the present application can improve an anti-interference performance of a finger gesture input, thereby improving operational accuracy. The embodiments are described in detail separately below.

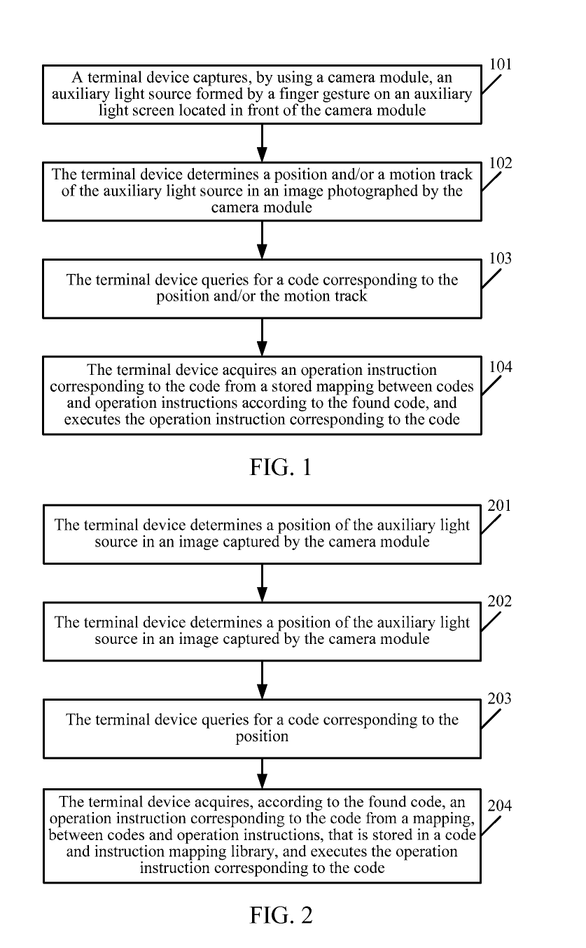

FIG. 1 is a flowchart of a human-computer interaction method according to some embodiments of the present application. As shown in FIG. 1, the human-computer interaction method in this embodiment starts from step 101.

Step 101: A terminal device captures, by using a camera module, an auxiliary light source formed by a finger gesture on an auxiliary light screen located in front of the camera module.

In an embodiment for implementing the present disclosure, the terminal device for implementing the human-computer interaction method may be a computer, a smart phone, or a television set in which the control software is installed and that has a computing capability, or may also be a household intelligent device, a commercial intelligent device, an office intelligent device, a mobile Internet device (MID), or the like, which is not specifically limited in this embodiment of the present application.

In this embodiment, the camera module may be built into the terminal device, which includes but is not limited to: a terminal device such as a notebook computer, a tablet computer, a smart phone, or a personal digital assistant (PDA), for example, a camera built in a terminal device such as a camera-equipped computer, a smart phone, a tablet computer, or a PDA. The camera module may also be disposed by being externally connected to the terminal device. For example, the camera module may be connected to the terminal device by using a universal serial bus (USB), the camera module may be connected to the terminal device by using a remote network (Wide Area Network, WAN), or the camera module may also be connected to the terminal device in a wireless manner such as Bluetooth, Wi-Fi, and infrared rays. In an embodiment of the present application, the camera may be built in the human-computer interaction terminal, externally connected to the human-computer interaction terminal, or disposed by combining the two manners. The connection manner between the camera and the human-computer interaction terminal may be: wired connection, wireless connection, or a combination of the two connection manners.

In an embodiment of the present application, the terminal device may capture, by using the camera module, the image that includes the auxiliary light source formed by the finger gesture on the auxiliary light screen, and process the image so as to acquire an image that only displays the auxiliary light source formed by the finger gesture on the auxiliary light screen, so that step 101 is implemented.

The embodiments of the present application will subsequently describe in detail, by using examples, the specific implementation procedures of processing the image by using the camera module, so as to acquire the image that only displays the auxiliary light source formed by the finger gesture on the auxiliary light screen, which are not described herein.

In an embodiment of the present application, the camera module may be an infrared-light camera. Correspondingly, the auxiliary light screen may be an infrared-light auxiliary light screen. In this case, the auxiliary light source formed by the finger gesture on the auxiliary light screen is a highlighted auxiliary light source.

In another embodiment of the present application, the camera module may be a visible-light camera. Correspondingly, the auxiliary light screen may be a visible-light auxiliary light screen. In this case, the auxiliary light source formed by the finger gesture on the auxiliary light screen is a dark auxiliary light source.

The embodiments of the present application will subsequently describe in detail the specific implementation of the auxiliary light screen, which are not described herein.

Step 102: The terminal device determines a position and/or a motion track of the auxiliary light source in an image captured by the camera module.

In an embodiment of the present application, if the finger touches the auxiliary light screen by means of tapping so as to form the auxiliary light source, the terminal device may determine a block number indicating where the auxiliary light source falls into the image captured by the camera module, and use the block number indicating where the auxiliary light source falls into the image captured by the camera module as a position of the auxiliary light source in the image captured by the camera module; and if the finger touches the auxiliary light screen by means of sliding so as to form the auxiliary light source, the terminal device may determine a quantity of blocks that the auxiliary light source goes through in the image captured by the camera module and a direction of the auxiliary light source, and use the quantity of the blocks that the auxiliary light source goes through in the image captured by the camera module and the direction of the auxiliary light source as a motion track of the auxiliary light source in the image captured by the camera module.

In this embodiment, the image captured by the camera module may be evenly divided into a plurality of blocks by the terminal device by using a certain corner (for example, an upper left corner) as an original point.

Step 103: The terminal device queries for a code corresponding to the position and/or the motion track.

In an embodiment of the present application, the control software of the terminal device may query, according to the block number indicating where the auxiliary light source falls into the image captured by the camera module, a stored mapping between blocks and codes for a code corresponding to the block number indicating where the auxiliary light source falls into the image captured by the camera module.

In another implementation of the present application, the control software of the terminal device may query, according to the quantity of the blocks that the auxiliary light source goes through in the image captured by the camera module and the direction of the auxiliary light source, a stored mapping among quantities of blocks, directions, and codes for a code corresponding to the quantity of the blocks that the auxiliary light source goes through in the image captured by the camera module and the direction of the auxiliary light source.

The embodiments of the present application will subsequently describe in detail the mapping between the blocks and the codes, and the mapping among the quantities of the blocks, the directions, and the codes, which are not described herein.

Step 104: The terminal device acquires an operation instruction corresponding to the code from a stored mapping between codes and operation instructions according to the found code, and executes the operation instruction corresponding to the code.

The embodiments of the present application will subsequently describe in detail the mapping between the codes and the operation instructions, which are not described herein.

In an embodiment of the present application, the operation instruction may be a computer operation instruction (for example, a mouse operation instruction such as opening, closing, zooming in, or zooming out) or a television remote control instruction (for example, a remote control operation instruction such as turning on, turning off, increasing volume, decreasing volume, switching to a lower channel number, switching to a higher channel number, or muting).

In an embodiment of the present application, the auxiliary light screen overlaps or is parallel to a display screen. When the auxiliary light screen is parallel to the display screen, the auxiliary light screen an infrared-light auxiliary light screen superposed with one visible-light light screen, and the visible-light light screen is used to indicate a position of the auxiliary light screen.

In the human-computer interaction method described in FIG. 1, a terminal device can capture, by using a camera module, an auxiliary light source formed by a finger gesture on an auxiliary light screen, determine a position and/or a motion track of the auxiliary light source in an image captured by the camera module, further query for a code corresponding to the position and/or the motion track, acquire an operation instruction corresponding to the code from a stored mapping between codes and operation instructions according to the code, and executes the operation instruction corresponding to the code. Therefore, the human-computer interaction method in FIG. 1 implements a human-computer interaction on the basis of an auxiliary light source, which not only achieves a very good anti-interference performance and higher operational accuracy, but also has a great commercial value.

The foregoing describes in detail the human-computer interaction method according to some embodiments of the present application.

According to yet another embodiment of the present application, a human-computer interaction method is further provided.

FIG. 2 is a flowchart of another human-computer interaction method according to another embodiment of the present application. In the human-computer interaction method in FIG. 2, it is assumed that a finger touches an auxiliary light screen by means of tapping so as form an auxiliary light source. As shown in FIG. 2, the human-computer interaction method may include the following steps.

Step 201: A terminal device can capture, by using a camera module, an auxiliary light source formed by a finger tap on an auxiliary light screen.

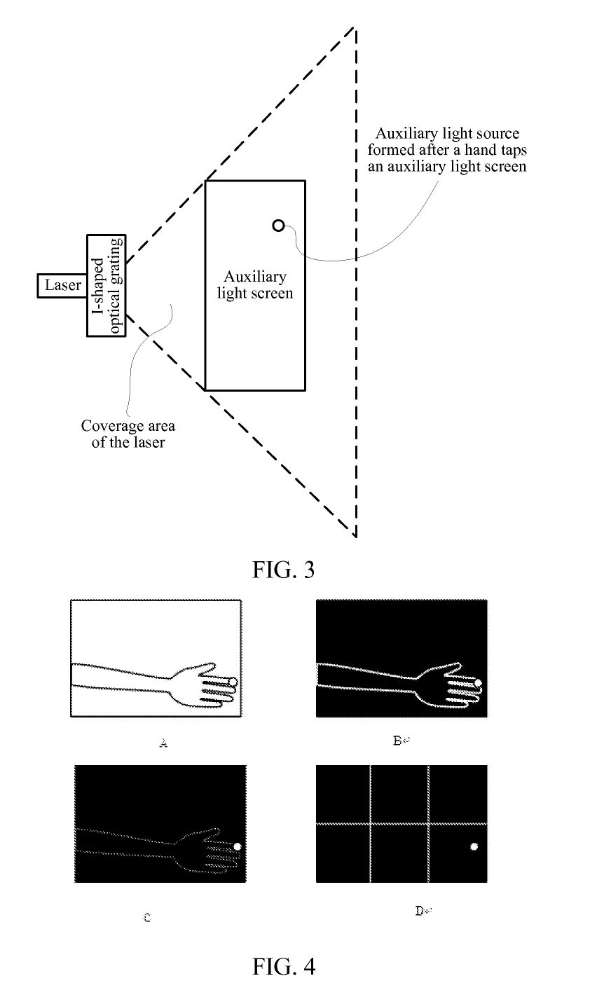

In an embodiment of the present application, reference is made to FIG. 3 for the specific implementation of the auxiliary light screen. The auxiliary light screen may use a laser plus an I-shaped optical grating as a light source. The light source may expand a single laser beam to a screen through the grating effect of the I-shaped optical grating, so as to implement the auxiliary light screen. Further, to achieve a more reliable and stable effect, the laser in FIG. 3 may be an infrared laser and the camera module may be an infrared-light camera module. Moreover, when the laser in FIG. 3 is an infrared laser, the auxiliary light screen is an infrared-light auxiliary light screen. In this case, the auxiliary light source that is formed by the finger tap on the auxiliary light screen and captured by the infrared-light camera module is a highlighted auxiliary light source. In another embodiment, the laser in FIG. 3 may be a visible-light laser and the camera module may also be a visible-light camera module. Moreover, when the laser in FIG. 3 is a visible-light laser, the auxiliary light screen is a visible-light auxiliary light screen. In this case, the auxiliary light source that is formed by the finger tap on the auxiliary light screen and captured by the visible-light camera module is a dark auxiliary light source.

In an embodiment of the present application, a mobile phone may also be used to illuminate the screen so as to implement the auxiliary light screen. This manner is simple and effective and also has a low cost.

In an embodiment of the present application, it is assumed that the laser in FIG. 3 is an infrared laser and the camera module is an infrared-light camera module. Correspondingly, the auxiliary light screen is an infrared-light auxiliary light screen. In this case, the auxiliary light source that is formed by the finger tap on the auxiliary light screen and captured by the camera module is a highlighted auxiliary light source. Therefore, the specific implementation of step 201 may include: the terminal device captures, by using the camera module, an image that includes the highlighted auxiliary light source formed by the finger tap on the auxiliary light screen, and processes the image so as to acquire an image that only displays the highlighted auxiliary light source formed by the finger tap on the auxiliary light screen.

Reference is made to FIG. 4 for the specific implementation procedures of processing the camera image so as to acquire an image that only displays the highlighted auxiliary light source formed by the finger tap on the auxiliary light screen. In FIG. 4, image A shows an image that is captured by the camera module in a normal condition and includes a highlighted auxiliary light source (indicated by a circle) formed by the finger tap on the auxiliary light screen, and image B shows an image that is captured by the camera module under a low exposure condition and includes the highlighted auxiliary light source (indicated by a circle) formed by the finger tap on the auxiliary light screen. As can be seen from image B, the image captured by the camera module under the low exposure condition further includes background noise such as a hand shape and other illuminating light apart from the highlighted auxiliary light source (indicated by a circle) formed by the finger tap on the auxiliary light screen, and the existence of these background noise reduces operational accuracy. Image C shows an image obtained after background impurity is removed from image B. Image D shows an image that only displays the highlighted auxiliary light source (indicated by a circle) formed by the finger tap on the auxiliary light screen after the background noise are thoroughly removed. The manners and the procedures for removing background noise from an image are all well-known by a person of ordinary skill in the art, which are not introduced in detail in this embodiment.

Step 202: The terminal device determines a position of the auxiliary light source in an image captured by the camera module.

In an embodiment of the present application, because the finger touches the auxiliary light screen by means of tapping so as to form the auxiliary light source, the terminal device may determine a block number indicating where the auxiliary light source falls into the image captured by the camera module, and use the block number indicating where the auxiliary light source falls into the image captured by the camera module as the position of the auxiliary light source in the image captured by the camera module.

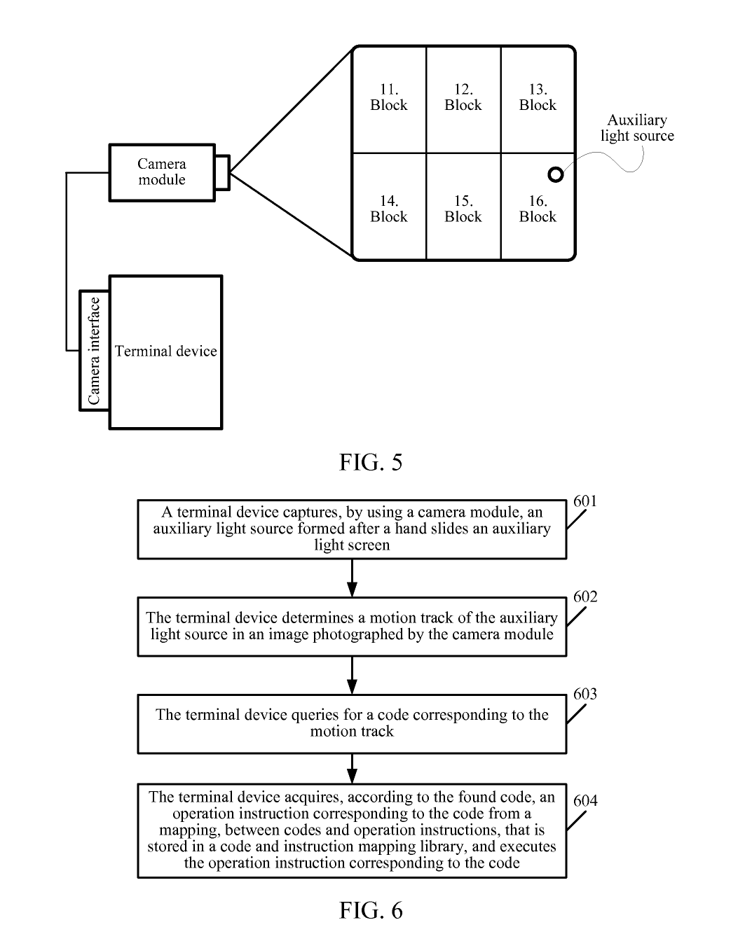

In an embodiment of the present application, as shown in FIG. 5, the terminal device may be connected to the camera module by using a camera interface. The terminal device may evenly divide the image captured by the camera module into a plurality of blocks by using a certain corner (for example, an upper left corner) of the image captured by the camera module as the origin of a coordinate system. As shown in FIG. 5, assuming that the auxiliary light source (indicated by a circle) falls into the sixteenth block in the image captured by the camera module, the terminal device may use the sixteenth block number indicating where the auxiliary light source falls into the image captured by the camera module as the position of the auxiliary light source (indicated by a circle) in the image captured by the camera module.

Step 203: The terminal device queries for a code corresponding to the position.

In an embodiment of the present application, the control software of the terminal device may query, according to the block number indicating where the auxiliary light source falls into the image captured by the camera module, a mapping, between blocks and codes, that is stored in a code library for a code corresponding to the block number indicating where the auxiliary light source falls into the image captured by the camera module.

In an embodiment of the present application, the mapping, between the blocks and the codes, that is stored in the code library is shown in table 1.

TABLE 1
Mapping, between blocks and codes, that is stored in a code library

| | Block parameters (where an upper left corner of an image captured |
|---|---|
| Codes | by a camera module is used as the origin of a coordinate system) |
| A | left border = 0, right border = image width/3, upper border = 0, lower |
| | border = image height/3 |
| B | left border = image width/3, right border = image width*2/3, upper |
| | border = 0, lower border = image height/3 |
| C | left border = image width*2/3, right border = image width, upper |
| | border = 0, lower border = image height/3 |
| D | left border = 0, right border = image width/3, upper border = image |
| | height/3, lower border = image height*2/3 |
| E | left border = image width/3, right border = image width*2/3, upper |
| | border = image height/3, lower border = image height*2/3 |
| F | left border = image width*2/3, right border = image width, upper |
| | border = image height/3, lower border = image height*2/3 |
| G | left border = 0, right border = image width/3, upper border = image |
| | height*2/3, lower border = image height |
| H | left border = image width/3, right border = image width*2/3, upper |
| | border = image height*2/3, lower border = image height |
| I | left border = image width*2/3, right border = image width, upper |
| | border = image height*2/3, lower border = image height |

In an embodiment of the present application, Table 1 shows that the terminal device evenly divides the image captured by the camera module into nine blocks by using the upper left corner of the image captured by the camera module as the original point. A person skilled in the art should understand that table 1 is only an embodiment and a user may also evenly divide the image captured by the camera module into more blocks according to the preference of the user and self-define more codes, so as to enrich operations on the terminal device.

For example, assuming that the block parameters of the block number indicating where the auxiliary light source falls into the image captured by the camera module is “left border=0, right border=image width/3, upper border=0, lower border=image height/3”, the control software of the terminal device may find, according to the block (indicated by “left border=0, right border=image width/3, upper border=0, lower border=image height/3”) that the auxiliary light source falls into the image captured by the camera module, that a code corresponding to the block number indicating where the auxiliary light source falls into the image captured by the camera module is code A from the mapping, between the blocks and the codes, that is stored in the code library shown in Table. 1.

In an embodiment of the present application, assuming that the block parameters of the block number indicating where the auxiliary light source falls into the image captured by the camera module is “left border=image width*⅔, right border=image width, upper border=image height*⅔, lower border=image height”, the control software of the terminal device may find, according to the block (indicated by “left border=image width*⅔, right border=image width, upper border=image height*⅔, lower border=image height”) that the auxiliary light source falls into the image captured by the camera module, that a code corresponding to the block number indicating where the auxiliary light source falls into the image captured by the camera module is I from the mapping, between the blocks and the codes, that is stored in the code library shown in Table. 1.

Step 204: The terminal device acquires, according to the found code, an operation instruction corresponding to the code from a mapping, between codes and operation instructions, which is stored in a code and instruction mapping library, and executes the operation instruction corresponding to the code.

In an embodiment of the present application, with reference to the mapping, between the blocks and the codes, that is stored in the code library shown in table 1, it is assumed that the mapping, between codes and the operation instructions, that is stored in the code and instruction mapping library is shown in table 2.

TABLE 2
Mapping, between codes and operation instructions, which
is stored in a code and instruction mapping library

| Codes | Instructions | Explanations |
|---|---|---|
| A | Increase | Increase volume when an auxiliary light source |
| | volume | appears in an upper left corner of an image |
| | | captured by a camera |
| B | Retain | Retain |
| C | Switch to a | Switch to a lower channel when an auxiliary |
| | lower channel | light source appears in an upper right corner of |
| | | an image captured by a camera |
| D | Decrease | Decrease volume when an auxiliary light source |
| | volume | appears on a left-middle area of an image |
| | | captured by a camera |
| E | Retain | Retain |
| F | Retain | Retain |
| G | Mute | Mute the sound when an auxiliary light source |
| | | appears in a lower left corner of an image |
| | | captured by a camera |
| H | Retain | Retain |
| I | Switch to a | Switch to a higher channel when an auxiliary |
| | higher channel | light source appears in a lower right corner of an |
| | | image captured by a camera |

In an embodiment of the present application, table 3 shows that: the mapping, between the codes and the operation instructions, that is stored in the code and instruction mapping library shown in table 2 is displayed on the nine blocks formed by evenly dividing the image captured by the camera module in table 1.

TABLE 3

| | | |
|---|---|---|
| Code: A | Code: B | Code: C |
| Operation instruction: | Operation instruction: | Operation instruction: |
| Increase volume | Retain | Switch to a lower |
| | | channel |
| Code: D | Code: E | Code: F |
| Operation instruction: | Operation instruction: | Operation instruction: |
| Decrease volume | Retain | Retain |
| Code: G | Code: H | Code: I |
| Operation instruction: | Operation instruction: | Operation instruction: |
| Mute | Retain | Switch to a higher |
| | | channel |

In the embodiment of the human-computer interaction method described in FIG. 2, the terminal device can capture, by using the camera module, an auxiliary light source formed by a finger tap on the auxiliary light screen, determine a position of the auxiliary light source in an image captured by the camera module, further query for a code corresponding to the position, acquire an operation instruction corresponding to the code from a stored mapping between the codes and the operation instructions according to the code, and execute the operation instruction corresponding to the code. Therefore, the human-computer interaction method described in FIG. 2 implements a human-computer interaction on the basis of an auxiliary light source, which not only achieves a very good anti-interference performance and higher operational accuracy, but also has a great commercial value.

The foregoing describes in detail the human-computer interaction method according to another embodiment of the present application.

According to another embodiment of the present application, another human-computer interaction method is further provided.

FIG. 6 is a flowchart of a human-computer interaction method according to another embodiment of the present application. The human-computer interaction method in FIG. 6 is described by using an example in which a finger touches an auxiliary light screen by means of sliding so as form an auxiliary light source. As shown in FIG. 6, the human-computer interaction method at least includes the following steps.

Step 601: A terminal device captures, by using a camera module, an auxiliary light source formed by a finger sliding on an auxiliary light screen.

In an embodiment of the present application, the specific implementation of the auxiliary light screen is introduced in detail in the preceding embodiments, which is not described again in this embodiment.

In an embodiment of the present application, the terminal device can capture, by using the camera module, an image that includes a highlighted auxiliary light source formed by a finger sliding on the auxiliary light screen, and processes the image so as to acquire an image that only displays the highlighted auxiliary light source formed by the finger sliding on the auxiliary light screen.

Step 602: The terminal device determines a motion track of the auxiliary light source in an image captured by the camera module.

In an embodiment of the present application, the terminal device may perform, by using the control software, continuous recognition on a sequence of images that only display highlighted auxiliary light sources formed after the hand slides the auxiliary light screen, so that the motion track of the auxiliary light source in the image captured by the camera module can be determined

In an embodiment of the present application, because the finger touches the auxiliary light screen by means of sliding so as to form the auxiliary light source, the terminal device may determine a quantity of blocks that the auxiliary light source goes through in the image captured by the camera module and a direction of the auxiliary light source, and use the quantity of the blocks that the auxiliary light source goes through in the image captured by the camera module and the direction of the auxiliary light source as the motion track of the auxiliary light source in the image captured by the camera module.

Step 603: The terminal device queries for a code corresponding to the motion track.

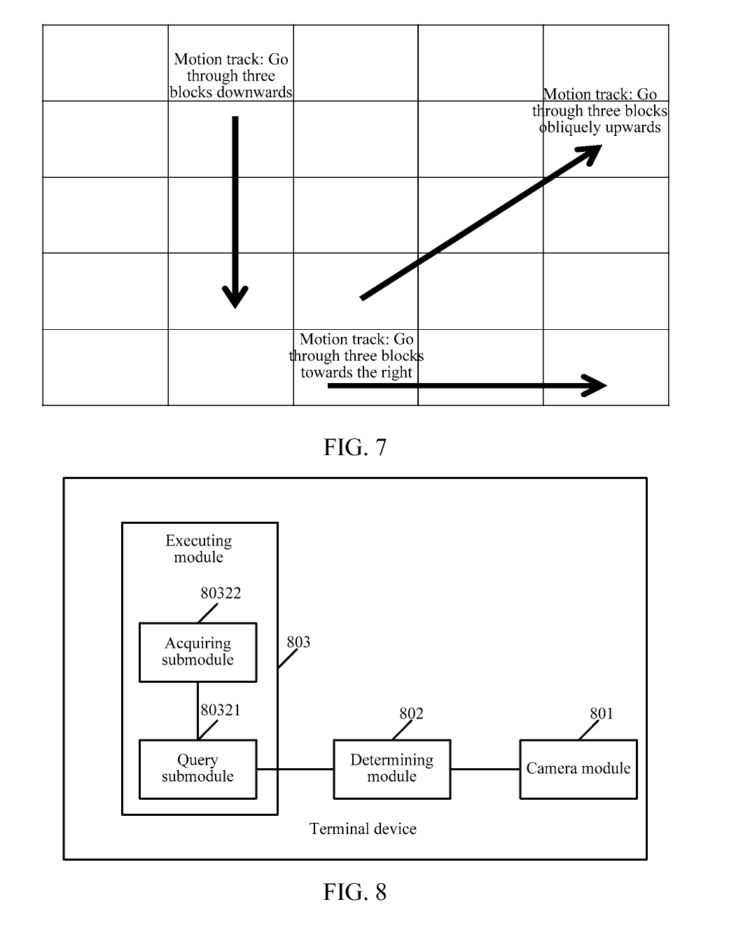

In an embodiment of the present application, a code library of the terminal device may pre-store a mapping among the quantities of the blocks that the auxiliary light source goes through in the image captured by the camera module, the directions of the auxiliary light source, and the codes, as shown in table 4. With reference to the attached table 4 below, assuming that the image captured by the camera module is evenly divided into a plurality of blocks shown in FIG. 7, the motion track is corresponding to a code as shown in table 4 when the auxiliary light source goes through three blocks downwards, the motion track is corresponding to a code b shown in table 4 when the auxiliary light source goes through three blocks towards the right, and the motion track is corresponding to a code c shown in table 4 when the auxiliary light source goes through three blocks obliquely upwards.

TABLE 4
Mapping among quantities of blocks that an auxiliary light source
goes through in an image captured by a camera module,
directions of the auxiliary light source, and codes

| Codes | Motion tracks |
|---|---|
| A | An auxiliary light source goes through three blocks |
| | downwards |
| B | An auxiliary light source goes through three blocks |
| | towards the right |
| C | An auxiliary light source goes through three blocks |
| | obliquely upwards |

As shown in FIG. 7, when the terminal device determines that the auxiliary light source goes through three blocks downward, the terminal device may find, by using the control software, that a corresponding code is code A according to the mapping among the quantities of the blocks that the auxiliary light source goes through in the image captured by the camera module, the directions of the auxiliary light source, and the codes, where the mapping is stored in the code library and shown in table 4.

Step 604: The terminal device acquires, according to the found code, an operation instruction corresponding to the code from a mapping, between codes and operation instructions, which is stored in a code and instruction mapping library, and executes the operation instruction corresponding to the code.

In an embodiment of the present application, with reference to the mapping, shown in table 4, among the quantities of the blocks that the auxiliary light source goes through in the image captured by the camera module, the directions of the auxiliary light source, and the codes, the code and instruction mapping library stores a mapping between codes and operation instructions, as shown in table 5.

TABLE 5
Mapping, between codes and operation instructions, which
is stored in a code and instruction mapping library

| Codes | Instructions | Explanations |
|---|---|---|
| A | Scroll down | Scroll down content when the auxiliary light |
| | content | source goes through three blocks downwards |
| B | Zoom in an | Zoom in an image when an auxiliary light source |
| | image | goes through three blocks obliquely upwards |
| C | Turn to a | Turn to a next page when an auxiliary light source |
| | next page | goes through three blocks towards the right |

In an embodiment of the present application, when the control software of the terminal device finds, according to the motion track of the auxiliary light source in the image captured by the camera module, that the motion track of the auxiliary light source in the image captured by the camera module is corresponding to the code a from table 4, the control software of the terminal device may further acquire that the operation instruction is “scroll down content” from table 5. In this case, the terminal device may be informed of executing the operation instruction to scroll down the content.

In the embodiment of the human-computer interaction method described in FIG. 6, a terminal device can capture, by using a camera module, an auxiliary light source formed by a finger sliding on the auxiliary light screen, determine a motion track of the auxiliary light source in an image captured by the camera module, further query for a code corresponding to the motion track, acquire an operation instruction corresponding to the code from a stored mapping between the codes and the operation instructions according to the code, and execute the operation instruction corresponding to the code. Therefore, the human-computer interaction method in FIG. 6 implements a human-computer interaction on the basis of an auxiliary light source, which not only achieves a good anti-interference performance and higher operational accuracy, but also has a great commercial value.

The foregoing describes in detail the human-computer interaction method according to some embodiments of the present application.

According to another embodiment of the present application, a terminal device is further provided.

FIG. 8 is a structural diagram of a terminal device according to another embodiment of the present application. The terminal device may be a computer, a smart phone, or a television set in which the control software is installed and that has a computing capability, or may also be a household intelligent device, a commercial intelligent device, an office intelligent device, an MID, or the like, which is not specifically limited in this embodiment of the present application. As shown in FIG. 8, the terminal device includes: a camera module 801, a determining module 802, and an executing module 803.

The camera module 801 captures an auxiliary light source formed by a finger gesture on an auxiliary light screen. For example, the camera module 801 captures, using a camera module, an image including the auxiliary light source formed by the finger gesture on the auxiliary light screen located in front of the camera module and then processes the image to acquire an image that only displays the auxiliary light source formed by the finger gesture on the auxiliary light screen.

The determining module 802 determines a position and/or a motion track of the auxiliary light source in an image captured by the camera module 801.

The executing module 803 executes a corresponding operation instruction according to the position and/or the motion track.

In an embodiment of the present application, the camera module 801 captures an image that includes the auxiliary light source formed by the finger gesture on the auxiliary light screen, and processes the image so as to acquire an image that only displays the auxiliary light source formed by the finger gesture on the auxiliary light screen.

In an embodiment of the present application, the determining module 802 determines a block that the auxiliary light source falls into in an image captured by the camera module 801; and/or determines a quantity of blocks that the auxiliary light source goes through in an image captured by the camera module 801 and a direction of the auxiliary light source. The image captured by the camera module 801 is evenly divided into a plurality of blocks (for example, by using an upper left corner as an original point).

As shown in FIG. 8, in a terminal device of an embodiment of the present application, the executing module 803 includes: a query submodule 80321 and an acquiring submodule 80322.

The query submodule 80321 queries for a code corresponding to the position and/or the motion track.

The acquiring submodule 80322 acquires an operation instruction corresponding to the code from a stored mapping between codes and operation instructions according to the code, and executes the operation instruction corresponding to the code.

In an embodiment of the present application, the query submodule 80321 queries, according to the block number indicating where the auxiliary light source falls into the image captured by the camera module 801, a stored mapping between blocks and codes for a code corresponding to the block number indicating where the auxiliary light source falls into the image captured by the camera module 801.

The query submodule 80321 may further query, according to a quantity of blocks that the auxiliary light source goes through in the image captured by the camera module 801 and a direction of the auxiliary light source, a stored mapping among quantities of blocks, directions, and codes for a code corresponding to the quantity of the blocks and the direction.

In an embodiment of the present application, the operation instruction may be either a computer operation instruction or a television remote control instruction, which is not limited in this embodiment.

According to an embodiment of the present application, the human-computer interaction method shown in FIG. 1 may be a human-computer interaction method executed by the units of the terminal device shown in FIG. 8. For example, step 101 shown in FIG. 1 may be executed by the camera module 801 shown in FIG. 8, step 102 shown in FIG. 1 may be executed by the determining module 802 shown in FIG. 8, step 103 shown in FIG. 1 may be executed by the query submodule 80321 of the executing module 803 shown in FIG. 8, and step 104 shown in FIG. 1 may be executed by the acquiring submodule 80322 of the executing module 803 shown in FIG. 8.

According to another embodiment of the present application, the units of the terminal device shown in FIG. 8 may be individually or entirely combined into one or more other units for constitution, or a certain (or some) of the units can also be divided into a plurality of units that are functionally smaller for constitution, which can also perform the same operations and does not affect the implementation of the technical effects of the embodiments of the present application. The foregoing units are divided based on logic functions and in practical applications, functions of one unit may also be implemented by a plurality of units; or functions of a plurality of units may be implemented by one unit. In other embodiments of the present application, the terminal device may also include other modules. However, in practical applications, these functions may also be implemented with assistant of other units and may be implemented through cooperation of a plurality of units.

According to another embodiment of the present application, a computer program (including program codes) capable of executing the human-computer interaction method shown in FIG. 1 may be run on a universal computer device, for example, a computer, that includes processing elements and storage media such as a central processing unit (CPU), a random access memory (RAM), and a read-only memory (ROM), to construct the terminal device shown in FIG. 8 and to implement the human-computer interaction method according to the embodiment of the present application. The computer program may be recorded, for example, in a computer readable recording medium, installed in the computing device by using the computer readable recording medium, and run therein.

The terminal device shown in FIG. 8 can capture, by using the camera module, an auxiliary light source formed by a finger gesture on the auxiliary light screen, determine a position and/or a motion track of the auxiliary light source in an image captured by the camera module, further query for a code corresponding to the position and/or the motion track, and execute an operation instruction corresponding to the code. Therefore, a human-computer interaction between the terminal device shown in FIG. 8 and human is implemented on the basis of an auxiliary light source, which not only achieves a very good anti-interference performance and higher operational accuracy, but also has a great commercial value.

The foregoing describes in detail the terminal device according to some embodiments of the present application.

According to another embodiment of the present application, a human-computer interaction system is further provided.

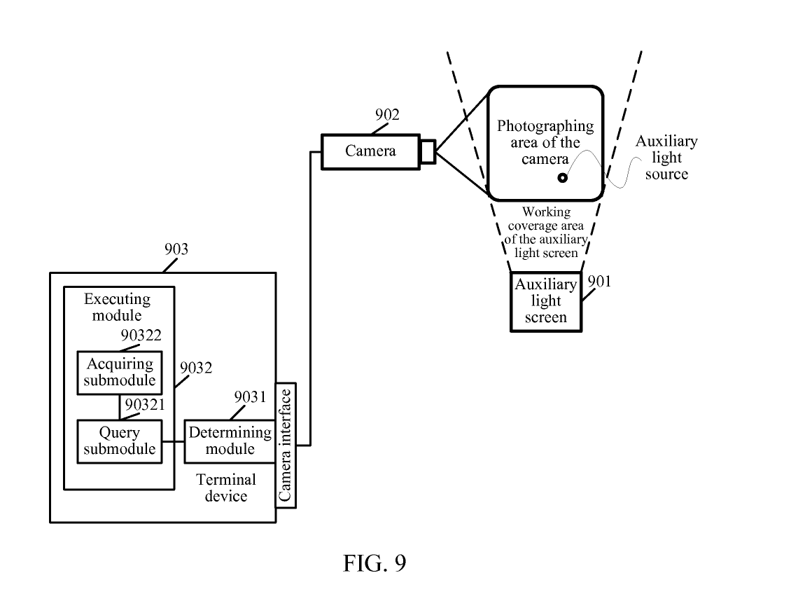

FIG. 9 is a structural diagram of a human-computer interaction system according to some embodiments of the present application. As shown in FIG. 9, the human-computer interaction system may include an auxiliary light screen 901, a camera 902, and a terminal device 903. The camera 902 may be built into the terminal device 903 or be connected to the terminal device 903 in a wired or wireless manner. A photographing area of the camera 902 covers a working coverage area of the auxiliary light screen 901. The human-computer interaction system shown in FIG. 9 is described by using an example in which the camera 902 is connected to the terminal device 903 in a wired manner.

The auxiliary light screen 901 is to be touched by a finger so as to form an auxiliary light source.

The camera 902 captures an auxiliary light source formed by a finger gesture on the auxiliary light screen 901.

The terminal device 903 includes: a determining module 9031 and an executing module 9032.

The determining module 9031 determines a position and/or a motion track of the auxiliary light source in an image captured by the camera 902.

The executing module 9032 executes a corresponding operation instruction according to the position and/or the motion track.

In an embodiment of the present application, the camera 902 specifically may capture an image that includes the auxiliary light source formed by the finger gesture on the auxiliary light screen, and process the image so as to acquire an image that only displays the auxiliary light source formed by the finger gesture on the auxiliary light screen.

In an embodiment of the present application, the determining module 9031 of the terminal device 903 specifically may determine a block that the auxiliary light source falls into in an image captured by the camera 902; and/or determine a quantity of blocks that the auxiliary light source goes through in an image captured by the camera 902 and the direction of the auxiliary light source. The image captured by the camera 902 is evenly divided into a plurality of blocks.

In this embodiment, the executing module 9032 of the terminal device 903 includes: a query submodule 90321 and an acquiring submodule 90322.

The query submodule 90321 queries for a code corresponding to the position and/or the motion track.

The acquiring submodule 90322 acquires an operation instruction corresponding to the code from a stored mapping between codes and operation instructions according to the code and executes the operation instruction corresponding to the code.

In an embodiment of the present application, the query submodule 90321 queries, according to the block number that the auxiliary light source falls into the image captured by the camera 902, a stored mapping between blocks and codes for a code corresponding to the block number that the auxiliary light source falls into the image captured by the camera 902.

The query submodule 90321 may further query, according to a quantity of blocks that the auxiliary light source goes through in the image captured by the camera 902 and a direction of the auxiliary light source, a stored mapping among quantities of blocks, directions, and codes for a code corresponding to the quantity of the blocks in the captured image and the direction.

In an embodiment of the present application, the operation instruction may be a computer operation instruction or a television remote control instruction, which is not limited in this embodiment.

In an embodiment of the present application, the camera 902 may be an infrared-light camera. Correspondingly, the auxiliary light screen 901 may be an infrared-light auxiliary light screen. The camera 902 may further be a visible-light camera. Correspondingly, the auxiliary light screen 901 may be a visible-light auxiliary light screen.

According to an embodiment of the present application, the human-computer interaction method shown in FIG. 1 may be a human-computer interaction method executed by the units of the human-computer interaction system shown in FIG. 9. For example, step 101 shown in FIG. 1 may be executed by the camera 902 shown in FIG. 9, step 102 shown in FIG. 1 may be executed by the determining module 9031 shown in FIG. 9, step 103 shown in FIG. 1 may be executed by the query submodule 90321 of the executing module 9032 shown in FIG. 9, and step 104 shown in FIG. 1 may be executed by the acquiring submodule 90322 of the executing module 9032 shown in FIG. 9.

According to another embodiment of the present application, the units of the human-computer interaction system shown in FIG. 9 may be individually or entirely combined into one or more other units for constitution, or a certain (or some) of the units can also be divided into a plurality of units that are functionally smaller for constitution, which can also perform the same operations and does not affect the implementation of the technical effects of the embodiments of the present application. The foregoing units are divided based on logic functions and in practical applications, functions of one unit may also be implemented by a plurality of units; or functions of a plurality of units may be implemented by one unit. In other embodiments of the present application, the human-computer interaction system may also include other modules. However, in practical applications, these functions may also be implemented with assistant of other units and may be implemented through cooperation of a plurality of units.

According to another embodiment of the present application, a computer program (including program codes) capable of executing the human-computer interaction method shown in FIG. 1 may be run on a universal computer device, for example, a computer, that includes processing elements and storage media, to construct the human-computer interaction system shown in FIG. 9 and to implement the human-computer interaction method according to the embodiment of the present application. The computer program may be recorded, for example, in a computer readable recording medium, installed in the computing device by using the computer readable recording medium, and run therein.

The storage media may include: a flash disk, a read-only memory (ROM), a random access memory (RAM), a magnetic disk, or an optical disc.

In the human-computer interaction system described in FIG. 9, a terminal device can capture, by using a camera, an auxiliary light source formed by a finger gesture on an auxiliary light screen, determine a position and/or a motion track of the auxiliary light source in an image captured by the camera, further query for a code corresponding to the position and/or the motion track, acquire an operation instruction corresponding to the code from a stored mapping between codes and operation instructions according to the code, and execute the operation instruction corresponding to the code. Therefore, the human-computer interaction system shown in FIG. 9 implements a human-computer interaction on the basis of an auxiliary light source, which not only achieves a good anti-interference performance and higher operational accuracy, but also has a great commercial value.

To sum up, by using the human-computer interaction method, and the related device and system according to the embodiments of the present application, when the auxiliary light screen is deployed on a desktop, the auxiliary light screen needs to be disposed in parallel with the desktop at a certain distance. Otherwise, a light trace may be formed, thereby affecting recognition. Certainly, the auxiliary light screen may be deployed on a wall surface or a desktop, or be deployed on a facade surface in air, so that a user can touch the auxiliary light screen in the air, thereby implementing a human-computer interaction operation. In addition, a dual-light screen including a visible-light light screen and an infrared-light light screen may be used as the auxiliary light screen, so that when the finger touches the auxiliary light screen, a finger is illuminated by the visible light and human eyes receive a feedback, and in addition, a camera captures a light spot (that is, the auxiliary light source) formed between the infrared-light auxiliary light screen and the finger.

The foregoing describes in detail the human-computer interaction method, and the related device and system provided in the embodiments of the present application. The principles and implementation manners of the present disclosure are described with specific examples to illustrate the above embodiments of the present application. However, the embodiments are not intended to limit the scope of the present disclosure and the scope of the present disclosure is defined by the appended claims. Any modification, equivalent replacement, or improvement made without departing from the spirit and principle of the present disclosure shall fall within the protection scope of the claims.

What is claimed is:

1. A human-computer interaction method, comprising:
at a terminal device having one or more processors and memory for storing program modules to be executed by the one or more processors:
capturing, using a camera module, an image including an auxiliary light source formed by a finger gesture on an auxiliary light screen located in front of the camera module;
processing the image to acquire an image that only displays the auxiliary light source formed by the finger gesture on the auxiliary light screen;
determining a position and/or a motion track of the auxiliary light source in the image captured by the camera module; and
executing a corresponding operation instruction according to the position and/or the motion track.

2. The method according to claim 1, wherein the determining step further comprises:
determining a block number indicating where the auxiliary light source falls into the image captured by the camera module; or
determining a quantity of blocks that the auxiliary light source goes through in the image captured by the camera module and a direction of the auxiliary light source;
wherein the image captured by the camera module is evenly divided into a plurality of blocks.

3. The method according to claim 2, wherein the executing step further comprises:
querying for a code corresponding to the position and/or the motion track; and
acquiring an operation instruction corresponding to the code from a stored mapping between codes and operation instructions according to the code and executing the operation instruction corresponding to the code.

4. The method according to claim 3, wherein the querying step further comprises:
querying, according to the block number indicating where the auxiliary light source falls into the image captured by the camera module, a stored mapping between blocks and codes for a code corresponding to the block number indicating where the auxiliary light source falls into the image captured by the camera module; or
querying, according to the quantity of the blocks that the auxiliary light source goes through in the image captured by the camera module and the direction of the auxiliary light source, a stored mapping among quantities of blocks, directions, and codes for a code corresponding to the quantity of the blocks that the auxiliary light source goes through in the image captured by the camera module and the direction of the auxiliary light source.

5. The method according to claim 1, wherein the auxiliary light screen overlaps or is parallel to a display screen.

6. The method according to claim 6, wherein the auxiliary light screen is parallel to the display screen, the auxiliary light screen is an infrared-light auxiliary light screen superposed with one visible-light light screen, and the visible-light light screen is used to indicate a position of the auxiliary light screen.

7. A terminal device having one or more processors, memory, and one or more program modules stored in the memory and to be executed by the one or more processors, the one or more program modules further comprising:
a camera module, configured to capture an image including an auxiliary light source formed by a finger gesture on an auxiliary light screen located in front of the camera module;
a processing module, configured to process the image to acquire an image that only displays the auxiliary light source formed by the finger gesture on the auxiliary light screen;
a determining module, configured to determine a position and/or a motion track of the auxiliary light source in an image captured by the camera module; and
an executing module, configured to execute a corresponding operation instruction according to the position and/or the motion track.

8. The terminal device according to claim 7, wherein the determining module is configured to determine a block number indicating where the auxiliary light source falls into the image captured by the camera module; and the determining module is configured to determine a quantity of blocks that the auxiliary light source goes through in the image captured by the camera module and a direction of the auxiliary light source, wherein the image captured by the camera module is evenly divided into a plurality of blocks.

9. The terminal device according to claim 8, wherein the executing module further comprises:
a query submodule, configured to query for a code corresponding to the position and/or the motion track; and
an acquiring submodule, configured to acquire an operation instruction corresponding to the code from a stored mapping between codes and operation instructions according to the code and execute the operation instruction corresponding to the code.

10. The terminal device according to claim 9, wherein the query submodule is configured to query, according to the block number indicating where the auxiliary light source falls into the image captured by the camera module, a stored mapping between blocks and codes for a code corresponding to the block number indicating where the auxiliary light source falls into the image captured by the camera module.

11. The terminal device according to claim 9, wherein the query submodule is configured to query, according to the quantity of the blocks that the auxiliary light source goes through in the image captured by the camera module and the direction of the auxiliary light source, a stored mapping among quantities of blocks, directions, and codes for a code corresponding to the quantity of the blocks that the auxiliary light source goes through in the image captured by the camera module and the direction of the auxiliary light source.

12. A human-computer interaction system, comprising an auxiliary light screen, a camera, and a terminal device, the camera being built into the terminal device or being connected to the terminal device in a wired or wireless manner, and a photographing area of the camera covering a working coverage area of the auxiliary light screen;
the auxiliary light screen being configured to be touched by a finger so as to form an auxiliary light source;
the camera being configured to capture the auxiliary light source formed by the finger gesture on the auxiliary light screen;
the terminal device further comprising:
a processing module, configured to process the image to acquire an image that only displays the auxiliary light source formed by the finger gesture on the auxiliary light screen;
a determining module, configured to determine a position and/or a motion track of the auxiliary light source in an image captured by the camera; and
an executing module, configured to execute a corresponding operation instruction according to the position and/or the motion track.

13. The human-computer interaction system according to claim 12, wherein the determining module is configured to determine a block number that the auxiliary light source falls into the image captured by the camera; and the determining module is configured to determine a quantity of blocks that the auxiliary light source goes through in the image captured by the camera and a direction of the auxiliary light source, wherein the image captured by the camera is evenly divided into a plurality of blocks.

14. The human-computer interaction system according to claim 13, wherein the executing module comprises:
a query submodule, configured to query for a code corresponding to the position and/or the motion track; and
an acquiring submodule, configured to acquire an operation instruction corresponding to the code from a stored mapping between codes and operation instructions according to the code, and execute the operation instruction corresponding to the code.

15. The human-computer interaction system according to claim 14, wherein the query submodule is configured to query, according to the block number that the auxiliary light source falls into the image captured by the camera, a stored mapping between blocks and codes for a code corresponding to the block number that the auxiliary light source falls into the image captured by the camera.

16. The human-computer interaction system according to claim 14, wherein the query submodule is configured to query, according to the quantity of the blocks that the auxiliary light source goes through in the image captured by the camera and the direction of the auxiliary light source, a stored mapping among quantities of blocks, directions, and codes for a code corresponding to the quantity of the blocks that the auxiliary light source goes through in the image captured by the camera and the direction of the auxiliary light source.

17. The human-computer interaction system according to claim 12, wherein the camera is an infrared-light camera and the auxiliary light screen is an infrared-light auxiliary light screen.

18. The human-computer interaction system according to claim 12, wherein the camera is a visible-light camera and the auxiliary light screen is a visible-light auxiliary light screen.
